(19) United States
(12) Patent Application Publication
(10) Pub. No.: US 2026/0349733 A1
(43) Pub. Date: Nov. 5, 2026

(54) BRANCH-WITH-LINK INSTRUCTION

(71) Applicant: Arm Limited, Cambridge (GB)

(72) Inventors: Roland MIKHEL, Budapest (HU); Tamás PETZ, Budapest (HU); Alexander Donald Charles CHADWICK, Cambridge (GB)

(21) Appl. No.: 19/194,341

(22) Filed: Apr. 30, 2025

(51) Int. Cl. G06F 9/30

(52) U.S. Cl. CPC G06F 9/30054

(57) ABSTRACT

An apparatus comprises an instruction decoder to decode instructions and processing circuitry to perform data processing in response to instructions decoded by the instruction decoder. In response to a first branch-with-link instruction indicative of a hint that a future return instruction is expected to return processing to an instruction subsequent to the first branch-with-link instruction following processing of a function, the instruction decoder controls the processing circuitry to trigger a non-sequential change of program flow to an instruction at a target address, and set, to a return address storage location, an address of the instruction subsequent to the first branch-with-link instruction; and at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.

### BACKGROUND

### Technical Field

The present technique relates to the field of data processing. In particular, the present technique relates to branch-with-link instructions.

### Technical Background

A computer program may include several points at which a subroutine or function is called. These may include a predefined block of instructions which can be called and executed at various points of the overall computer program. This allows the block of instructions to be stored at a set of addresses in memory and then fetched when needed instead of being replicated one or more times into the usual sequential flow of the computer program. A data processing apparatus may therefore support a branch-with-link instruction for calling the subroutine and storing information for returning to the original program flow after the subroutine has completed.

### SUMMARY

At least some examples of the present technique provide an apparatus comprising: an instruction decoder configured to decode instructions; and processing circuitry configured to perform data processing in response to instructions decoded by the instruction decoder, wherein in response to a first branch-with-link instruction indicative of a hint that a future return instruction is expected to return processing to an instruction subsequent to the first branch-with-link instruction following processing of a function called by the first branch-with-link instruction, the instruction decoder is configured to control the processing circuitry to: trigger a non-sequential change of program flow to an instruction at a target address, and set, to a return address storage location, an address of the instruction subsequent to the first branch-with-link instruction; and at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.

At least some examples of the present technique provide a system comprising: the apparatus as described above implemented in at least one packaged chip; at least one system component; and a board, wherein the at least one packaged chip and the at least one system component are assembled on the board.

At least some examples of the present technique provide a chip-containing product comprising the system as described above, wherein the system is assembled on a further board with at least one other product component.

At least some examples of the present technique provide a method comprising: decoding instructions; and performing data processing in response to decoded instructions, wherein in response to a first branch-with-link instruction indicative of a hint that a future return instruction is expected to return processing to an instruction subsequent to the first branch-with-link instruction following processing of a function called by the first branch-with-link instruction: triggering a non-sequential change of program flow to an instruction at a target address, and setting, to a return address storage location, an address of the instruction subsequent to the first branch-with-link instruction; and at least when the first branch-with-link instruction is a chainable variant and the instruction at the target address comprises a second branch-with-link instruction, causing the second branch-with-link instruction to be treated as a non-return-address-setting branch-with-link instruction for which update of the return address storage location is suppressed.

At least some examples of the present technique provide computer-readable code for fabrication of an apparatus comprising: an instruction decoder configured to decode instructions; and processing circuitry configured to perform data processing in response to instructions decoded by the instruction decoder, wherein in response to a first branch-with-link instruction indicative of a hint that a future return instruction is expected to return processing to an instruction subsequent to the first branch-with-link instruction following processing of a function called by the first branch-with-link instruction, the instruction decoder is configured to control the processing circuitry to: trigger a non-sequential change of program flow to an instruction at a target address, and set, to a return address storage location, an address of the instruction subsequent to the first branch-with-link instruction; and at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.

At least some examples of the present technique provide a computer program for controlling a host data processing apparatus to provide an instruction execution environment comprising: instruction decoding program logic configured to decode instructions; and processing program logic configured to perform data processing in response to instructions decoded by the instruction decoding program logic, wherein in response to a first branch-with-link instruction indicative of a hint that a future return instruction is expected to return processing to an instruction subsequent to the first branch-with-link instruction following processing of a function called by the first branch-with-link instruction, the instruction decoding program logic is configured to control the processing program logic to: trigger a non-sequential change of program flow to an instruction at a target address, and set, to a return address storage location, an address of the instruction subsequent to the first branch-with-link instruction; and at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.

At least some examples of the present technique provide a method of compiling a sequence of program instructions to generate a compiled program, the method comprising: determining branch information indicative of a given calling point of program flow at which the program flow is to be non-sequentially changed to a subroutine point, for which an instruction address offset between the given calling point and the subroutine point exceeds a predetermined threshold; identifying whether an intervening calling point exists between the given calling point and the subroutine point, the intervening calling point comprising a point at which the program flow is to be non-sequentially changed to the subroutine point, wherein an instruction address offset between the given calling point and the intervening calling point does not exceed the predetermined threshold; and in response to identifying that the intervening calling point exists, generating a chainable variant of a branch-with-link instruction for the given calling point, the chainable variant of the branch-with-link instruction specifying a target address corresponding to the intervening calling point, wherein the chainable variant of the branch-with-link instruction, when executed, causes: a non-sequential change of program flow to the intervening calling point; an address of an instruction subsequent to the chainable variant of the branch-with-link instruction to be set to a return address storage location; and a further branch-with-link instruction at the intervening calling point to be treated as a non-return-address-setting branch-with-link instruction, for which updating the return address storage location is suppressed.

Further aspects, features and advantages of the present technique will be apparent from the following description of examples, which is to be read in conjunction with the accompanying drawings.

### BRIEF DESCRIPTION OF THE DRAWINGS

FIG. 1 illustrates a data processing apparatus comprising a branch unit and a branch predictor;

FIG. 2 illustrates an example of a branch unit;

FIGS. 3A and 3B illustrate examples of program flow when calling a subroutine;

FIG. 4 illustrates a sequence of steps for determining how to treat a second branch-with-link instruction;

FIG. 5 illustrates a sequence of steps for controlling whether to update a return address storage location;

FIG. 6 illustrates how to control a chaining indicator;

FIG. 7 illustrates a branch predictor comprising a branch chaining predictor;

FIG. 8 illustrates a sequence of steps for predicting how a second branch-with-link instruction will be treated;

FIG. 9 illustrates a sequence of steps for controlling a chain prediction indicator;

FIG. 10 illustrates a sequence of steps for applying an architectural constraint on a branch-with-link instruction;

FIG. 11 illustrates an example of a compiler;

FIG. 12 illustrates a sequence of steps for compiling program code including branch-with-link instructions;

FIG. 13 illustrates a system and a chip-containing product;

FIG. 14 illustrates a simulator implementation.

### DESCRIPTION OF EXAMPLES

An apparatus comprises an instruction decoder configured to decode instructions; and processing circuitry configured to perform data processing in response to instructions decoded by the instruction decoder. The instruction decoder supports a branch-with-link (BL) instruction used to indicate a hint that a future return instruction is expected to return processing to an instruction subsequent to the BL instruction following processing of a function called by the BL instruction. In response to a BL instruction, the instruction decoder is configured to control the processing circuitry to trigger a non-sequential change of program flow to an instruction at a target address, and set, to a return address storage location, an address of the instruction subsequent to the first BL instruction.

In some scenarios, larger non-sequential changes that are triggered by a BL instruction may be less efficient than smaller non-sequential changes. Furthermore, a BL instruction may be limited in the size of non-sequential change that may be specified (or at least the BL instruction may be subject to additional overheads if the non-sequential change is greater than a given threshold, so that it may be preferable to be able to use a BL instruction with a smaller branch distance when possible).

According to the present techniques, the instruction decoder is configured to support a chainable variant of a BL instruction. In response to a first BL instruction, at least when the first BL instruction is a chainable variant and the instruction at the target address includes a second BL instruction, the instruction decoder is configured to control the processing circuitry to perform the functions above, and to cause the second BL instruction to be treated as a non-return-address-setting BL instruction for which update of the return address storage location is suppressed. Therefore, the chainable variant of a BL instruction allows the first BL instruction to be followed by a second BL instruction without the return address storage location being updated. Accordingly, the non-sequential change of the first BL instruction may be ‘chained’ together with a non-sequential change of a second BL instruction while still behaving like a single function call (in the sense that after completion of the subroutine, the processing returns to the return address set in the return address storage location for the first BL instruction). This allows calling a subroutine at a greater distance from the current program flow location of the first BL instruction using a chain of BL instructions each with a shorter branch distance, to enable a given practical restriction on branch distance for an individual BL instruction to be overcome.

In some examples, in response to the non-return-address-setting BL instruction, the instruction decoder is configured to control the processing circuitry to trigger a non-sequential change of program flow to an instruction at a target address of the non-return-address-setting BL instruction and suppress updating the return address storage location. According to these examples, a non-sequential change of program flow is triggered while retaining the return address that had been previously stored in the return address storage location. In an example sequence of instructions where the first BL instruction described above triggers a chain of non-sequential changes to a function, the non-return-address-setting BL instruction acts as one ‘link’ in the chain to extend the total non-sequential change without behaving like a function call itself. Hence, in response to the future return instruction (as hinted by the first BL instruction) following processing of the function, a non-sequential change of program flow may be triggered back to the instruction subsequent to the first BL instruction, because that address had been retained in the return address storage location. It will be appreciated therefore, that executing the non-return-address-setting BL instruction without updating the return address storage location enables a single return instruction to return the program flow to the instruction subsequent to the first BL instruction, regardless of how many intervening non-return-setting BL instructions had been executed. Hence, the code efficiency may be further improved.

In some examples, in response to a given BL instruction encountered without the given BL instruction being at a target address of a preceding instance of the chainable variant of the BL instruction, the instruction decoder is configured to treat the given BL instruction as a return-address-setting BL instruction for which update of the return address storage location is permitted. In such examples, the given BL instruction is possible to encounter when it is not the target of a preceding BL instruction, e.g. the given BL instruction may be encountered during sequential program flow. Hence, the given BL instruction is treated as a return-address-setting BL instruction which is permitted to update the return address storage location. It will be appreciated therefore, that a given BL instruction may be treated either as a return-address-setting BL instruction or a non-return-address-setting BL instruction depending on how the given BL instruction is encountered, i.e. whether the given BL instruction is encountered as a target of a preceding chainable variant of the BL instruction.

In some examples, at least when the BL instruction is the chainable variant, the instruction decoder is configured to control the processing circuitry to set a chaining indicator to indicate that a chaining condition is satisfied. While the chaining condition is satisfied, it may be assumed that any encountered BL instructions are part of a chain initiated by a preceding BL instruction. Hence, the processing circuitry may be configured to determine, based on the chaining indicator, whether to treat a given BL instruction as the non-return-address-setting BL instruction.

In some examples, in response to the given BL instruction when the chaining indicator indicates that the chaining condition is not satisfied, the instruction decoder is configured to cause the given BL instruction to be treated as a return-address-setting BL instruction for which update of the return address storage location is permitted.

In some examples, in response to a non-chaining instruction when the chaining indicator indicates that the chaining condition is satisfied, the instruction decoder is configured to control the processing circuitry to set the chaining indicator to indicate that the chaining condition is not satisfied. In such examples, it is recognised that a chainable variant of a BL instruction may be executed (and hence the chaining indicator set to indicate that the chaining condition is satisfied), even when the target address is not that of a BL instruction and no chain is to be formed. Hence, these examples provide a way of resetting the chaining indicator to indicate that the chaining condition is not satisfied in response to a non-chaining instruction. One such example is where, for a given instruction set architecture, there is no distinction between chainable and non-chainable variants of BL instructions. In other words, all BL instructions may be a chainable variant and may be used even when the formation of a chain is unnecessary.

The non-chaining indication may comprise any instruction that is not a chainable BL instruction. For example, this may include a non-branch instruction, a branch instruction that is not indicative of a hint that a future return instruction is expected to return processing to an instruction subsequent to the branch instruction (i.e. a branch instruction other than a BL instruction), and a BL instruction that is not the chainable variant.

In some examples, the apparatus may provide one or more machine state registers for controlling how instructions are executed. The chaining indicator may therefore comprise one or more bits of a machine state register.

In some examples, the apparatus further comprises branch prediction circuitry configured to capture, in response to identifying an address predicted to correspond to a predicted BL instruction, a predicted return address associated with an instruction subsequent to the predicted BL instruction, wherein at least when the predicted BL instruction is predicted to: be the chainable variant, and target a further BL instruction, the branch prediction circuitry is configured to generate a prediction that the further BL instruction is to be taken, without capturing a further return address indicating an instruction subsequent to the further BL instruction. The branch prediction circuitry may therefore generate predictions to take account of the predicted BL instructions being the chainable variant. The branch prediction circuitry may operate, albeit speculatively, in an analogous way to the actual execution of the chainable variant of BL instructions described previously. In particular, if the predicted BL instruction is predicted to target a further BL instruction, then the further return address is not captured for the further BL instruction. In some examples, the branch prediction circuitry may track a speculative list of return addresses using a call-return stack. Hence, predicting the outcome of the further BL instruction may omit pushing the further return address onto the call-return stack.

In some examples, at least when the predicted BL instruction is predicted to be the chainable variant, the branch prediction circuitry is configured to set a chain prediction indicator to indicate that a chaining condition is satisfied. The chain prediction indicator may be used as a speculative analogue of the chaining indicator described previously. Hence, in response to a BL instruction being predicted while the chain prediction indicator is set to indicate that the chaining condition is satisfied, the branch prediction circuitry is configured to suppress return address capture for that BL instruction.

In some examples, in response to predicting occurrence of a non-chaining instruction, e.g. such as the non-chaining instructions described above, the branch prediction circuitry is configured to set the chain prediction indicator to indicate that the chaining condition is not satisfied. As above, this may operate in an analogous way to the chaining indicator described previously.

It will be appreciated that, while reference has been made to the chaining indicator described previously, it is not necessary for both the chaining indicator and the chain prediction indicator to be used in combination. Indeed, various examples may include only one of these indicators.

In some examples, the first BL instruction comprises an identifier of whether the first BL instruction is the chainable variant. In such examples, an instruction set architecture supported by the instruction decoder may include chainable and non-chainable variants which may be encoded differently.

In other examples, the instruction decoder may identify whether the first BL instruction is the chainable variant in dependence on a mode indication held in a control register. For example, a control register may be written to by a more privileged process (e.g. a hypervisor or an operating system) to enable or disable the chaining functionality. In examples where an instruction set architecture does not provide both chainable and non-chainable variants, BL instructions may be treated as chainable unless chaining has been disabled in the control register, in which case the BL instructions are treated as non-chainable.

As mentioned earlier, the size of the non-sequential change that may be triggered by a BL instruction may be limited. In some examples, the processing circuitry is configured to process instructions according to an instruction set architecture which imposes an architectural constraint on the first BL instruction which causes branching from the first BL instruction to a target address outside a predetermined range from an instruction address of the first BL instruction to be more restricted in comparison to branching from the first BL instruction to a target address within the predetermined range from the instruction address of the first BL instruction. The imposed architectural constraint therefore imposes one limit on the size of the non-sequential change.

In some examples, according to the architectural constraint, in response to the first BL instruction when the target address is outside the predetermined range from the instruction address of the BL instruction, the processing circuitry is configured to perform a guard check to verify whether an instruction at the target address corresponds to one of a set of permitted branch target instructions. For example, where memory is partitioned into different regions of varying security, a guard check may be used to verify that the process executing the first BL instruction is allowed to branch to the target address. In response to the first BL instruction when the target address is within the predetermined range from the instruction address of the first BL instruction, the processing circuitry is configured to omit the guard check. For example, the guard check may comprise checking whether the instruction at the branch target address is a guard instruction (a designated type of instruction representing a valid branch target point in the program). This protects against attacks based on compromising the operands of a branch instruction so as to branch into the middle of a function which is not intended to be a valid branch target point.

In some examples, the first BL instruction comprises a target address field for identifying the target address as a relative address offset relative to the instruction address of the first BL instruction, and the architectural constraint comprises an encoding constraint restricting a maximum address offset supported by the target address field, such that the first BL instruction is incapable of branching to a target address outside the predetermined range from the instruction address of the first BL instruction. The encoding constraint may be inherent to the instruction set architecture supported by the apparatus in terms of how many bits are available for representing the instruction and/or the instruction's operand(s).

In some examples, an apparatus embodying the concepts described above may be simulated by simulation software executing on a host data processing apparatus. In particular, a computer program may be provided to control a host data processing apparatus (which may not embody the above concepts) to provide an instruction execution environment comprising program logic to simulate the hardware features described above.

In some examples, an apparatus embodying the concepts described above may defined in computer-readable code for fabrication of the apparatus.

Computer programs such as those described above may be stored on a computer-readable medium, which may be transitory or non-transitory.

For creating computer program to run on an apparatus embodying the concepts described above, there is also provided a method of compiling a sequence of program instructions to generate a compiled program. A computer program may be written by a programmer in a higher level programming language, such as C++, Python or Java, in which a programmer may define calls to subroutines. A compiler may use the subroutine call information for generating the sequence of program instructions in a lower level programming language, e.g. assembly or machine code. In particular, a compiler may identify calling points and subroutines and determine that the non-sequential change between the given calling point and the subroutine point has an instruction address offset that exceeds a predetermined threshold. This predetermined threshold may be set according to any known architectural constraints imposed by the instruction set architecture supported by the apparatus for which code is being compiled, such as those described above.

It can then be identified whether an intervening calling point exists between the given calling point and the subroutine point. The intervening calling point is selected to be another point at which the program flow is to be non-sequentially changed to the subroutine point (i.e. the same subroutine as the given calling point). The instruction address offset between the given calling point and the intervening calling point is selected not to exceed the predetermined threshold. If such an intervening calling point does exist, then the compiler may generate a chainable variant of a BL instruction for the given calling point, such that the BL instruction specifies a target address corresponding to the intervening calling point. The chainable variant of the BL instruction, when executed, causes a non-sequential change of program flow to the intervening calling point, an address of an instruction subsequent to the chainable variant of the BL instruction to be set to a return address storage location, and a further BL instruction at the intervening calling point to be treated as a non-return-address-setting BL instruction, for which updating the return address storage location is suppressed. Accordingly, the compiler may generate output code containing the beginning of a chain of BL instructions as described previously.

It will be appreciated that if an address offset between the intervening calling point and the subroutine point also exceeds the predetermined threshold, then it may be identified whether a further intervening calling point exists. If so, then another chainable variant of the BL instruction is generated for the intervening calling point. This process may repeat several times to ‘chain’ multiple calling points together, such that the program flow can be changed to the subroutine point further away from the initial calling point than the predetermined threshold, without any individual non-sequential change of program flow requiring an address offset that exceeds the predetermined threshold.

The compiler described above may be embodied as a computer program product, for example as computer-readable code. Such computer-readable code may be stored on a computer-readable storage medium which may be non-transitory.

Particular embodiments will now be described with reference to the figures.

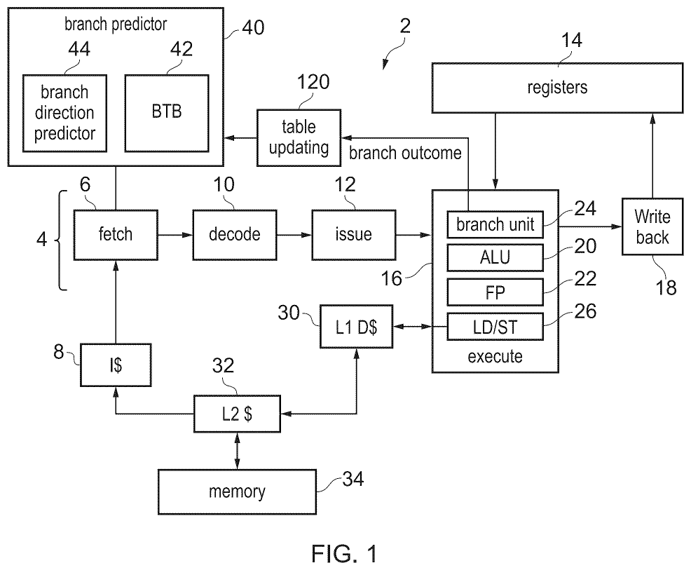

FIG. 1 schematically illustrates an example of a data processing apparatus 2. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor a register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness.

The decode stage 10 supports a BL instruction, which is indicative of a hint that a future return instruction is expected to return processing to an instruction subsequent to the BL instruction following processing of a function called by the BL instruction. The BL instruction specifies a target address, for example, with an address offset encoded in an address field of the instruction.

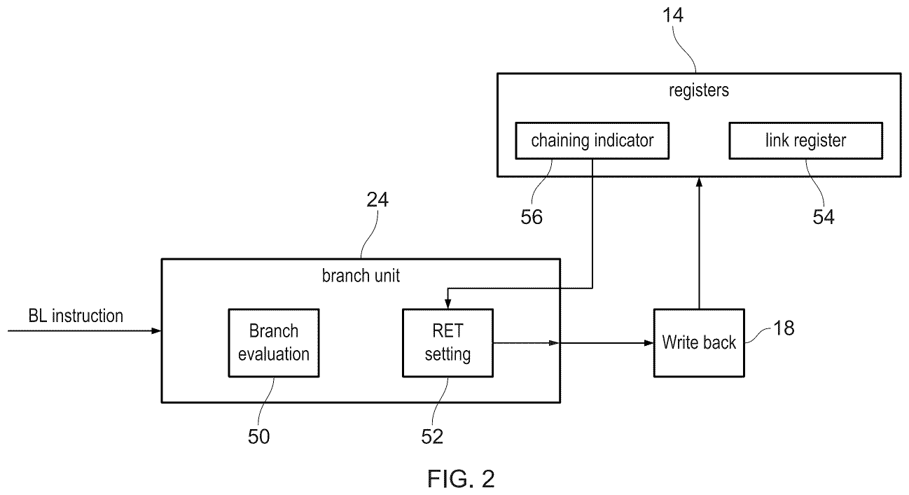

FIG. 2 illustrates the branch unit 28 for performing micro-operations corresponding to a decoded BL instruction. The branch unit 28 comprises branch evaluation circuitry 50 for evaluating the outcome of the branch. Since BL instructions are generally used for calling functions, they are treated as unconditional branches and hence the evaluation circuitry 50 evaluates the outcome of a BL instruction as taken. It will nonetheless be appreciated that other branch instructions may be dependent on one or more conditions which are checked to evaluate whether the branch is taken or not taken. Based on the evaluated outcome, the branch unit 24 adjusts the program flow counter, i.e. by the amount indicated by the address offset specified by the BL instruction, thereby causing a non-sequential change in the program flow. The branch unit 24 further comprises return address setting circuitry 52 which outputs the address of the instruction subsequent to the BL instruction to the writeback stage 18, which then stores that address as the return address in the link register 54 among the registers 14. This return address provides a target address for a return instruction, which is expected to be encountered after processing the function so that the program flow can return to the point before the function was called.

In accordance with the present techniques, the decode stage 10 supports a chainable variant of the BL instruction. When a BL instruction is a chainable variant and the instruction at the target address comprises second BL instruction, the branch unit 24 treats the second BL instruction as a non-return-address-setting BL instruction for which update of the link register 54 is suppressed. Accordingly, if a BL instruction is received and is to be treated as a non-return-address-setting BL instruction, the branch unit 24 causes a non-sequential change of program flow to be triggered as described above, but any update of the link register 54 is suppressed. Accordingly, if a return address is received in the future, the return address in the link register 54 is expected to still correspond to the address subsequent to the first BL instruction.

Whether or not a BL instruction is to be treated as a non-return-address-setting BL instruction may be controlled by a chaining indicator 56 (which may be provided by one of the registers 14). In response to the chainable variant of the BL instruction, the branch unit 24 may set the chaining indicator to indicate that a chaining condition is satisfied. Then while the chaining condition is indicated as satisfied, the return address setting circuitry 52 is suppressed from updating the link register for subsequently received BL instructions.

In various examples, the apparatus 2 may be configured to impose at least one architectural constraint on BL instructions which causes branching to be more restricted if the target address is beyond a predetermined range of the instruction address of the BL instruction. Particular examples of the architectural constraint will be described later, but it will nonetheless be appreciated that executing the branch without being subject to the restriction from the architectural constraint may result in the program being executed more efficiently. The chainable variant of the BL instruction may be used to ‘chain’ a plurality of BL instructions together, so that branching to the target address may be achieved in a plurality of smaller branches, thereby avoiding a restriction from the architectural constraint.

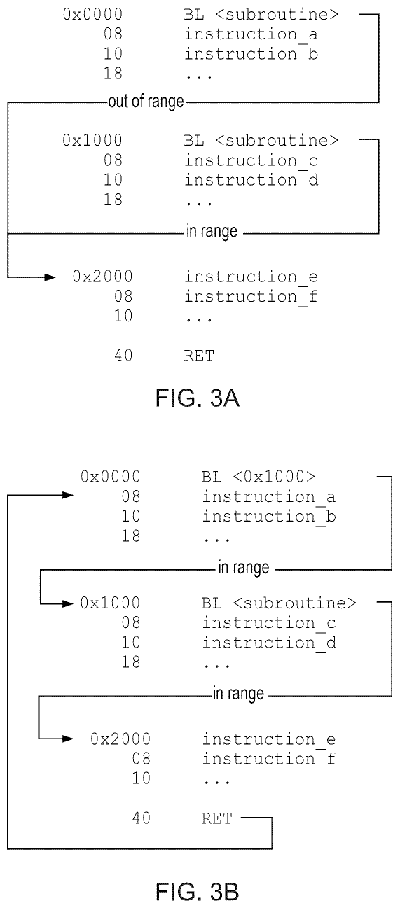

To illustrate the difference in program flow, a comparative example is provided in FIGS. 3A and 3B. In these examples, an architectural constraint is assumed to cause branches to be more restricted when the address offset between the instruction address and the target address exceeds 0x1000. It will be appreciated that such values are purely for illustrative purposes and the architectural constraint may be applied to any other predetermined range.

In FIG. 3A, a first BL instruction has an instruction address of 0x0000 and targets the subroutine at the address 0x2000. The address offset between these is 0x2000, and hence is beyond the predetermined range. The first BL instruction in this example will therefore be more restricted by the architectural constraint. By contrast, a second BL instruction also targets the same subroutine, but since the second BL instruction has an instruction address of 0x1000, the address offset is 0x1000. Hence, the subroutine address is within the predetermined range of the second BL instruction. The second BL instruction therefore will be less restricted.

To allow the first BL instruction to be executed without being restricted by the architectural constraint, the chainable variant according to the present techniques may be used. FIG. 3B illustrates how the chainable variant of the BL instruction may be used to effectively extend the range of a BL instruction without being restricted by the architectural constraint. As in FIG. 3A, the first BL instruction at address 0x0000 is still beyond the predetermined range from the subroutine at the address 0x2000. However, in FIG. 3B the first BL instruction is a chainable variant targeting the second BL instruction at 0x1000, which is within the predetermined range. Accordingly, the first BL instruction may be executed without being restricted by the architectural constraint. The program flow is therefore non-sequentially changed to the second BL instruction at 0x1000. Additionally, the address of the instruction subsequent to the first BL instruction, i.e. instruction_a at 0x0008 is written to the link register 54. In examples that include the chaining indicator 56, the chaining indicator 56 may also be set to indicate that a chaining condition is satisfied.

The second BL instruction may then be executed to trigger a non-sequential change of program flow to the subroutine at 0x2000. As above, since these addresses are within the predetermined range, the execution of the second BL instruction is not restricted by the architectural constraint. Due to the first BL instruction being a chainable variant and the chaining condition currently being satisfied, the second BL instruction is treated as a non-return-address-setting BL instruction. Accordingly, where the second BL instruction would conventionally set the address of instruction_c (i.e. 0x1008) to the link register 54, this is suppressed so that the return address corresponding to the first BL instruction may be preserved.

The instructions of the subroutine may then be executed. When instruction_e is encountered, it may be identified, e.g. by the decode stage 10, that this is a non-chaining instruction. This may be any instruction other than the chainable variant of the BL instructions. For example, instruction_e may be a memory access instruction, an arithmetic instruction, or a branch instruction other than a BL instruction. Hence, the branch unit 24 may determine that the BL chain has ended, and therefore sets the chaining indicator 56 to indicate that the chaining condition is no longer satisfied. Accordingly, the way in which the branch unit 24 handles BL instructions is reset, such that if the BL instruction at 0x1000 is later encountered during ordinary sequential program flow (i.e. instead of as a target of a preceding chainable BL instruction), then that BL instruction may be treated as a return-address-setting BL instruction as would be expected.

After performing the instructions in the subroutine, a return instruction is encountered at 0x2040. In response to the return instruction, the branch unit 24 retrieves the return address from the link register 54. Since the second BL instruction was prevented from updating the link register 54, the return address is still the address of instruction_a (i.e. the instruction subsequent to the first BL instruction). The branch unit 24 therefore adjusts the program counter value to trigger a non-sequential change of program flow back to instruction_a.

It will be appreciated that, when using the chainable variant of the BL instruction, the return instruction may return to the first BL instruction in the chain regardless of how many intervening BL instructions were executed. In particular, while FIG. 3B only illustrates one intervening non-return-address-setting BL instruction, there may be any number of non-return-address-setting BL instructions chained together following the first chainable BL instruction and the return address will still be for the instruction subsequent to the first chainable BL instruction. This program flow is therefore to be distinguished from that of nested functions, in which a return instruction returns to the instruction subsequent to the most-recently-executed BL instruction due to that BL instruction updating the address in the link register 54. Hence, for nested functions, multiple return instructions (i.e. equal to the amount of BL instructions) would have to be executed to return processing back to the instruction subsequent to the first BL instruction. The present techniques of providing the chainable BL instruction which causes a second BL instruction to be treated as a non-return-address-setting BL instruction therefore allows for improved code efficiency both when calling and returning from a function.

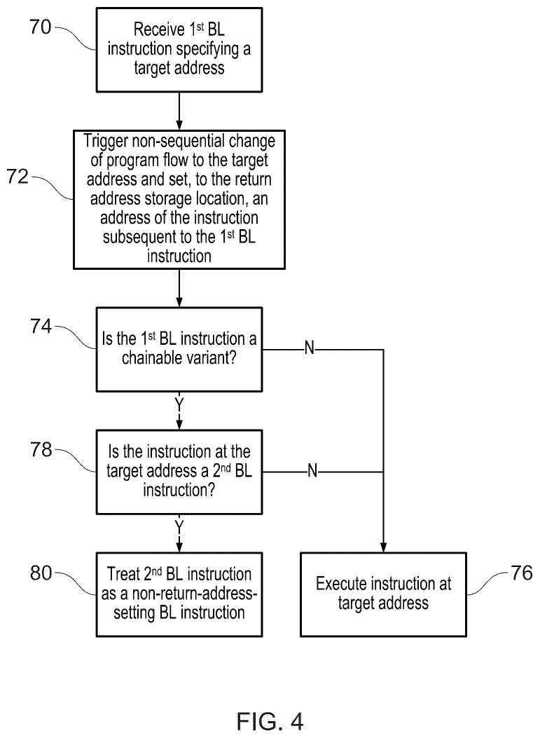

FIG. 4 illustrates a sequence of steps for executing a BL instruction according to some examples. At step 70, a first BL instruction specifying a target address is received. At step 72, the branch unit 24 triggers a non-sequential change of program flow to the target address and sets, to a return address storage location (e.g. the link register 54), an address of the instruction subsequent to the first BL instruction. It will be appreciated that step 72 may occur regardless of whether the first BL instruction is a chainable variant.

At step 74, it is determined whether the first BL instruction is a chainable variant. If not, then no additional steps are required, and execution proceeds to the instruction at the target address at step 76. If the first BL instruction is the chainable variant, then at step 78, it is determined whether the instruction at the target address is a second BL instruction. If not, then no additional steps are required, and execution proceeds to the instruction at the target address at step 76. However, if the instruction at the target address is a second BL instruction, then the second BL instruction is treated as a non-return-address-setting BL instruction at step 80.

It will be appreciated that steps 72 and 74 need not be performed in the illustrated order and may be performed the other way around or even in parallel. In some examples, step 74 may not need to be an explicit determination. For example, a given instruction set architecture may not distinguish between chainable variants and non-chainable variants, such that all BL instructions are treated as a chainable variant. In other examples, step 74 may be performed based on a mode indication held in a control register, such that in a chaining mode, BL instructions are treated as being the chainable variant, whereas in a non-chaining mode, BL instructions are not treated as being the non-chainable variant.

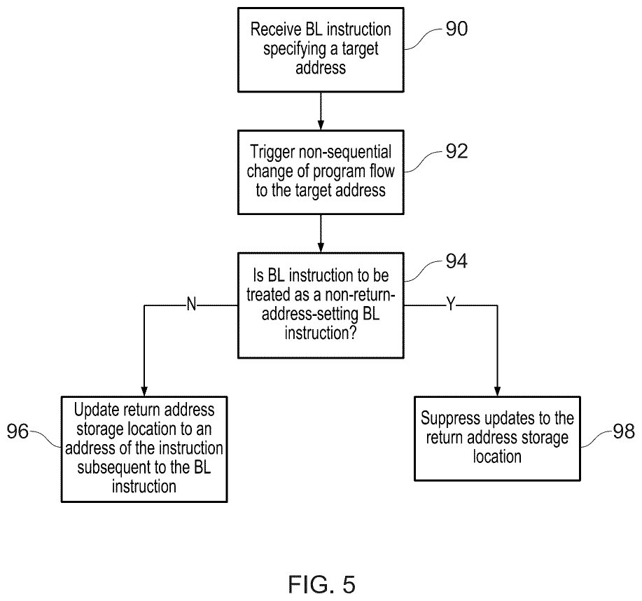

FIG. 5 illustrates a sequence of steps for executing a BL instruction according to some examples. At step 90, a BL instruction specifying a target address is received. At step 92, the branch unit 24 triggers a non-sequential change of program flow to the target address. At step 94, it is determined whether this BL instruction is to be treated as a non-return-address-setting BL instruction. For example, the return address setting circuitry 52 may read the current state of the chaining indicator 56 to determine whether the chaining condition is satisfied. If not, then the BL instruction is treated as a return-address-setting BL instruction and, at step 96, the return address storage location is updated to the address of the instruction subsequent to the BL instruction. Step 96 may therefore correspond to a case in which the BL instruction has been encountered during normal program flow, e.g. sequentially, instead of as a target of a preceding chainable BL instruction. In other words, the BL instruction received in step 90 is not a link in a chain of BL instructions.

On the other hand, if the BL instruction is to be treated as a non-return-address-setting BL instruction, then at step 98, the update to the return address storage location is suppressed. This may therefore correspond to a case in which the BL instruction has been encountered as part of a chain of BL instructions. Hence, the return address in the return address storage location is intended to be kept as the address of the instruction following the first BL instruction in the chain, as described in previous examples.

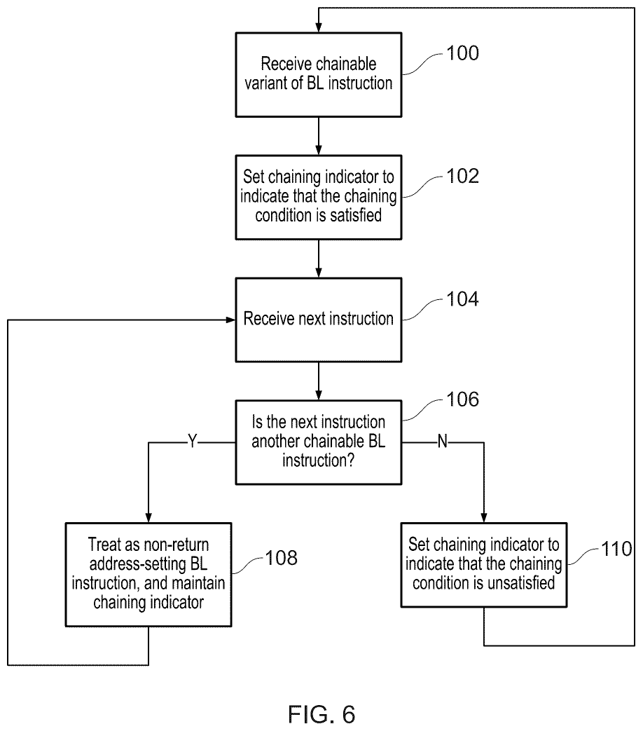

FIG. 6 illustrates an example of how the chaining indicator 56 may be controlled. At step 100, a chainable variant of a BL instruction is received. At step 102, the chaining indicator 56 is set to indicate that the chaining condition is satisfied. At step 104, a next instruction is received. At step 106, it is determined whether the next instruction is another chainable BL instruction. If so, then at step 108, the chainable BL instruction is treated as a non-return-address-setting BL instruction, and the chaining indicator 56 is maintained, i.e. to continue indicating that the chaining condition is satisfied. Accordingly, it may be determined that the chain of BL instructions has not yet ended. The process may then repeat from step 104 to receive another instruction, which may or may not be another chainable BL instruction.

If the instruction is not another chainable BL instruction at step 106, then at step 110, the chaining indicator 56 is set to indicate that the chaining condition is unsatisfied. This therefore indicates that the chain of BL instructions has ended, and a further BL instruction may be treated as a return-address-setting BL instruction. The process may then wait return to step 100 for another occurrence of a chainable variant of the BL instruction.

The examples described above therefore provide an apparatus supporting a chainable variant of the BL instruction which, when executed, causes a subsequent BL instruction to be treated as a non-return-address-setting BL instruction. When implemented into a computer program, the chainable variants of the BL instruction may be chained together to call a function that otherwise would be out-of-range.

Returning to FIG. 1, the apparatus 2 includes a branch predictor 40 for predicting outcomes of branch instructions. The branch predictor is looked up based on addresses of instructions provided by the fetch stage 6 and provides a prediction on whether those instructions are predicted to include branch instructions, and for any predicted branch instructions, a prediction of their branch properties such as a branch type, branch target address and branch direction (predicted branch outcome, indicating whether the branch is predicted to be taken or not taken). The branch predictor 40 includes a branch target buffer (BTB) 42 for predicting properties of the branches other than branch direction, and a branch direction predictor (BDP) 44 for predicting the not taken/taken outcome (branch direction). It will be appreciated that the branch predictor could also include other prediction structures such as a call-return stack for predicting return addresses of function calls, a loop direction predictor for predicting when a loop controlling instruction will terminate a loop, or other more specialised types of branch prediction structures for predicting behaviour of outcomes in specific scenarios. One such specialised type of branch prediction structure may consider whether a predicted branch instruction is a chainable variant of a BL instruction or not.

As shown in FIG. 1, the apparatus 2 may have table updating circuitry 120 which receives signals from the branch unit 24 indicating the actual branch outcome of instructions, such as indications of whether a taken branch was detected in a given block of instructions, and if so the detected branch type, target address or other properties. If a branch was detected to be not taken then this is also provided to the table updating circuitry 120. The table updating circuitry 120 then updates state within the BTB 42, the BDP 44 and other branch prediction structures to take account of the actual results seen for an executed block of instructions, so that it is more likely that on encountering the same block of instructions again then a correct prediction can be made.

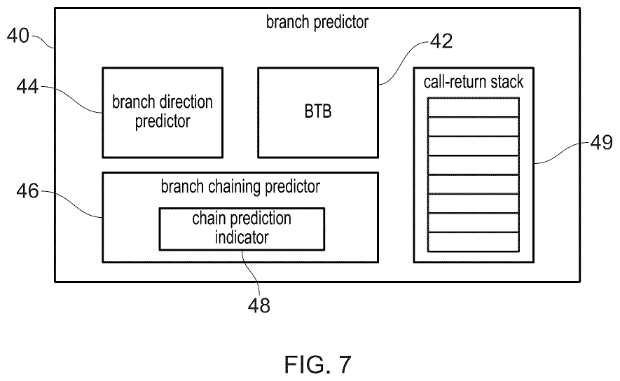

FIG. 7 illustrates a branch predictor 40 which is configured to predict the chainable variant of the BL instruction. When predicting a BL instruction, the branch predictor 40 captures a return address associated with the instruction subsequent to the predicted BL instruction. The captured return address may be pushed onto the call-return stack 49, which then provides the predicted target address when predicting a return instruction. The branch predictor 40 comprises a branch chaining predictor 46 which may operate alongside the BTB 42 and the BDP 44 such that it can be predicted whether the BL instruction is a chainable variant. The predicted target address may be obtained from the BTB 42 as described above for prediction of whether the BL instruction targets a further BL instruction. In accordance with the present techniques, if the predicted BL instruction is predicted to be a chainable variant and target a further BL instruction, the branch predictor 40 generates a prediction that the further BL instruction is to be taken but does not capture a return address. Accordingly, the call-return stack 49 is not updated when predicting the further BL instruction.

Accordingly, the branch predictor 40 may generate predictions for each branch in a chain of BL instructions that may be executed by the branch unit 24 as described in previous examples. Since a return address is not captured for each prediction, the call-return stack 49 still has the return address captured from the first predicted BL instruction. Therefore, when the branch predictor 40 predicts a return instruction, the prediction is generated based on that return address.

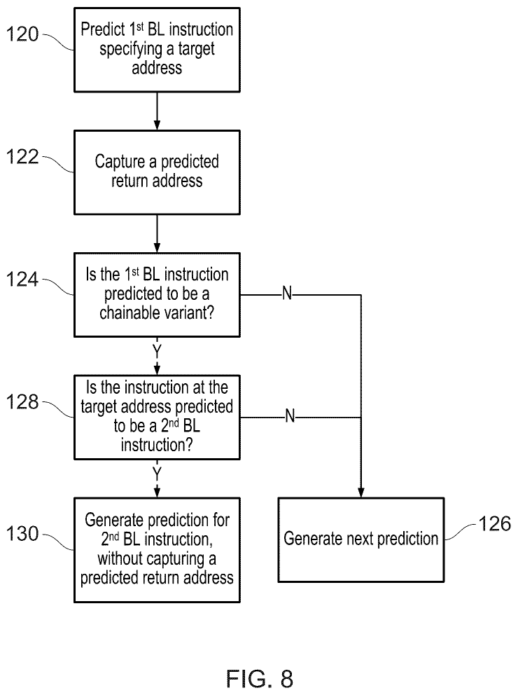

FIG. 8 illustrates a sequence of steps for performing branch prediction according to some examples. At step 120, a first BL instruction specifying a target address is predicted. At step 122, the branch predictor 40 captures a return address (e.g. using the call-return stack 49), associated with the instruction subsequent to the first BL instruction. It will be appreciated that step 122 may occur regardless of whether the first BL instruction is a chainable variant.

At step 124, it is determined whether the first BL instruction is predicted to be a chainable variant. If not, then no additional steps are required, and a next prediction is generated in respect of the next address at step 126. If the first BL instruction is predicted to be the chainable variant, then at step 128, a prediction is generated for whether the instruction at the target address is predicted to be a second BL instruction. If not, then no additional steps are required, and execution proceeds to the instruction at the target address at step 126. However, if the instruction at the target address is predicted to be a second BL instruction, then the branch predictor 40 generates a prediction for the second BL instruction without capturing a predicted return address at step 130.

It will be appreciated that the procedure in FIG. 8 corresponds to the process of executing a chainable BL instruction in FIG. 4. Accordingly, the branch predictor 40 in this example is capable of generating appropriate predictions in respect of the chainable variant of BL instructions. Similar to the description of FIG. 4, it will be appreciated that steps 124 and 128 need not be performed in the illustrated order and may be performed the other way around or even in parallel. In some examples, step 124 may not need to be an explicit determination. For example, a given instruction set architecture may not distinguish between chainable variants and non-chainable variants, such that all predicted BL instructions are predicted to be the chainable variant. In other examples, step 124 may be performed based on a mode indication held in a control register, such that in a chaining mode, BL instructions are treated as being the chainable variant, whereas in a non-chaining mode, BL instructions are not treated as being the chainable variant.

In some examples, the branch chaining predictor 46 may maintain a chain prediction indicator 48 which may behave in a similar way to the chaining indicator 56 described previously. In particular, the chain prediction indicator 48 may indicate whether a chaining condition is satisfied for predicting the BL instructions. In other words, the chain prediction indicator 48 may provide an indication of whether the chaining indicator 56 is predicted to be satisfied when the current predictions are being resolved. Accordingly, in some examples, step 128 may include setting the chain prediction indicator 48 to indicate that the chaining condition is satisfied. Hence, if the next predicted instruction is a second BL instruction, the prediction is generated without capturing a predicted return address at step 130. Otherwise, the prediction is generated normally at step 126. Similar to the chaining indicator 56 described previously, generating a prediction for a non-chaining instruction may cause the chain prediction indicator 48 to be updated to indicate that the chaining condition is no longer satisfied.

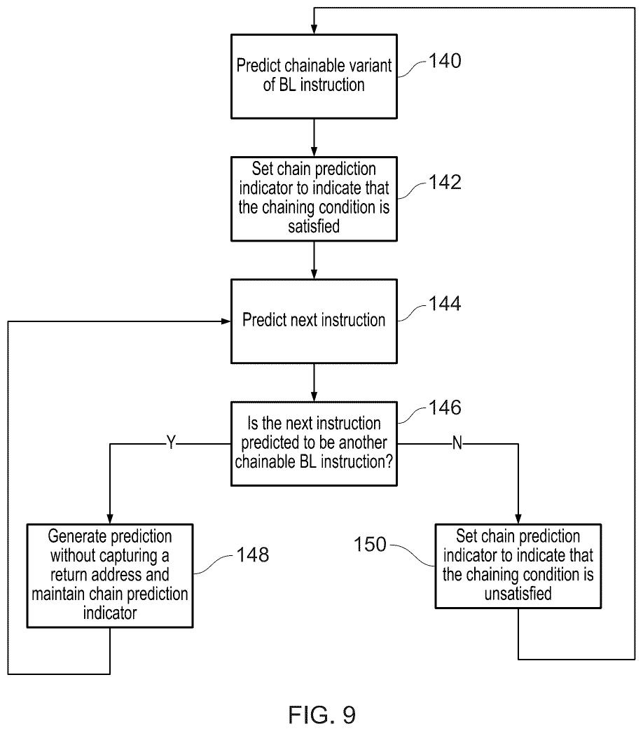

FIG. 9 illustrates an example of how the chain prediction indicator 48 may be controlled. At step 140, a chainable variant of a BL instruction is predicted. At step 142, the chain prediction indicator 48 is set to indicate that the chaining condition is satisfied. At step 144, a next instruction is predicted. At step 146, a prediction is generated for whether the next instruction is predicted to be another chainable BL instruction. If so, then at step 148, a prediction is generated for the chainable BL instruction without capturing a return address, and chain prediction indicator 48 is maintained, i.e. to continue indicating that the chaining condition is satisfied. Accordingly, it may be predicted that the chain of BL instructions has not yet ended. The process may then repeat from step 144 to predict another instruction, which may or may not be another chainable BL instruction.

If the instruction is not predicted to be another chainable BL instruction at step 146, then at step 150, the chain prediction indicator 48 is set to indicate that the chaining condition is unsatisfied. This therefore indicates that the chain of BL instructions is predicted to have ended, and a prediction generated in respect of a further BL instruction may include capturing a return address. The process may then wait return to step 140 for another prediction of a chainable variant of the BL instruction.

These examples therefore provide a branch predictor 40 that is suitable for handling the generation of branch predictions for an apparatus supporting the chainable variant of the BL instruction described previously.

As described above, an instruction set architecture may impose an architectural constraint on a BL instruction such that branching from the BL instruction to a target address outside of a predetermined range from the instruction address is more restricted in comparison to branching to a target address within the predetermined range. One example of this is an encoding constraint due to limited encoding space within the instruction. In particular, a BL instruction generally comprises a target address field specifying the target address as part of the instruction encoding. This may be contrasted with, for example, a branch-with-link-to-register (BLR) instruction which specifies a register containing the target address. Therefore, the target address that may be specified by the BL instruction may be restricted to a maximum address offset that may be supported within the number of bits available in the target address field of the instruction. It will be appreciated that this may be fewer bits than would be available in a register. Accordingly, the maximum address offset that may be encoded in the BL instruction defines the predetermined range referred to above. While one approach to extend the range of the branch would be to simply use a BLR instruction, this requires one or more preceding instructions to be included in the computer program, e.g. to derive the target address and write it to a register. This therefore reduces the code efficiency due to more instructions having to be performed to obtain a similar functionality (also use of the register to provide the target address increases register pressure which may increase the likelihood that more variables which could otherwise be held in registers have to be spilled out to memory, reducing performance). The present techniques therefore allow a chainable BL instruction to branch further without incurring the added overhead of the BLR instruction.

Alternatively or in addition, the architectural constraint may be a requirement that a BL instruction specifying a target address outside of a predetermined range (i.e. potentially a different range to that imposed by the encoding constraint) requires a guard check to be successfully performed. A guard check is an operation that may be performed by the execute stage 16 to verify whether the instruction at the target address corresponds to one of a set of permitted branch target instructions. If the instruction at the target address is among the set of permitted branch target instructions, then the non-sequential change in program flow is allowed to proceed, otherwise an exception may be raised. This approach enables the valid function entry points to be limited to the locations marked by a permitted branch target instruction, to reduce risk of attack based on an attacker causing a branch into the middle of a function not at a valid function entry point. In some scenarios, it may be deemed that the risk of such attack may be greater for branches with a branch offset greater than a given threshold (e.g. a 4K page size) than for branches with a smaller offset within the threshold (e.g. the 4K threshold can be useful because intra-page branches within the same page would be to locations with the same memory access permissions as the BL instruction itself, so less likely to be branching to attacker-controlled gadget code at an arbitrary location in memory than branches outside the current page).

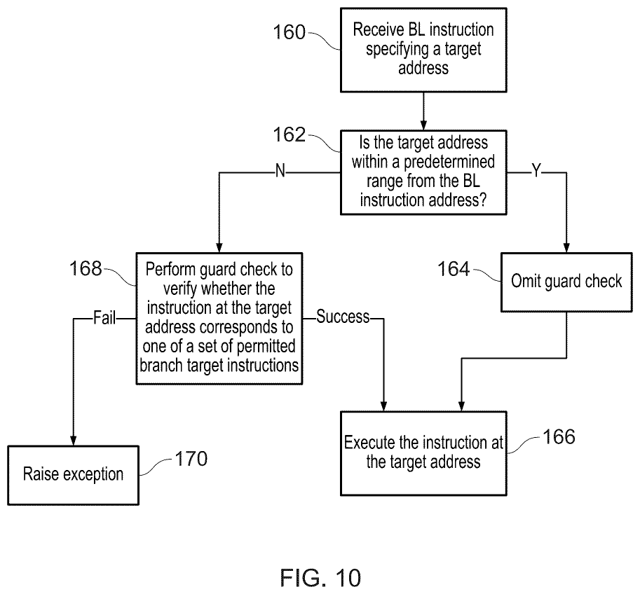

FIG. 10 illustrates a sequence of steps for performing a guard check for a given BL instruction. At step 160, a BL instruction is received specifying a target address. At step 162, it is determined whether the target address is within a predetermined range from the instruction address of the BL instruction. If so, then the guard check is not required and hence the guard check is omitted at step 164. The instruction at the target address may then be executed at step 166. However, if the target address is not within the predetermined range, then a guard check is required. Therefore, at step 168, the guard check is performed to verify whether the instruction at the target address corresponds to one of a set of permitted branch target instructions. If not, then an exception is raised at step 170. However, if the guard check is successful, then the instruction at the target address is executed at step 166.

It can therefore be clearly seen that avoiding the guard check in this example can provide an improvement to code density by avoiding the need to encode additional guard (branch target) instructions at the branch target address for each function entry. Hence, as described above, the present techniques of chaining a BL instruction to another BL instruction that is within range allows a series of smaller non-sequential changes in program flow that are each within the respective predetermined range of each BL instruction. Accordingly, the overall non-sequential change may be larger than would be ordinarily permitted by the architecture.

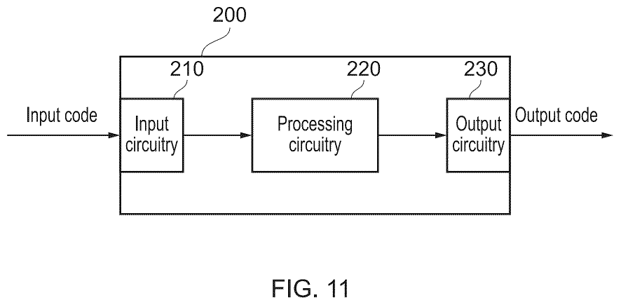

FIG. 11 illustrates a compiler 200, which may be embodied as a data processing apparatus. The compiler could be a regular compiler or a just-in-time compiler for instance. The data processing apparatus could also be embodied as part of a pipeline, for instance the pipeline 4 described in previous examples. The behaviour of the compiler 200 may also be embodied in a computer program which, when executed on a data processing apparatus (which may be a general-purpose data processing apparatus) causes the data processing apparatus to behave in a corresponding way to the compiler 200. Such a computer program may be stored on a transitory or non-transitory computer-readable medium. Within the compiler 200, input circuitry receives input code, which is processed by processing circuitry 220 to produce output code, which is output by output circuitry 230. The input code includes blocks of instructions which may be written in a higher-level programming language and may contain subroutine calls that is interpreted by the compiler 200 to identify one or more points at which program flow is to be non-sequentially changed. The output code corresponds to the input code, but may include non-sequential changes in program flow being performed by one or more chainable BL instructions.

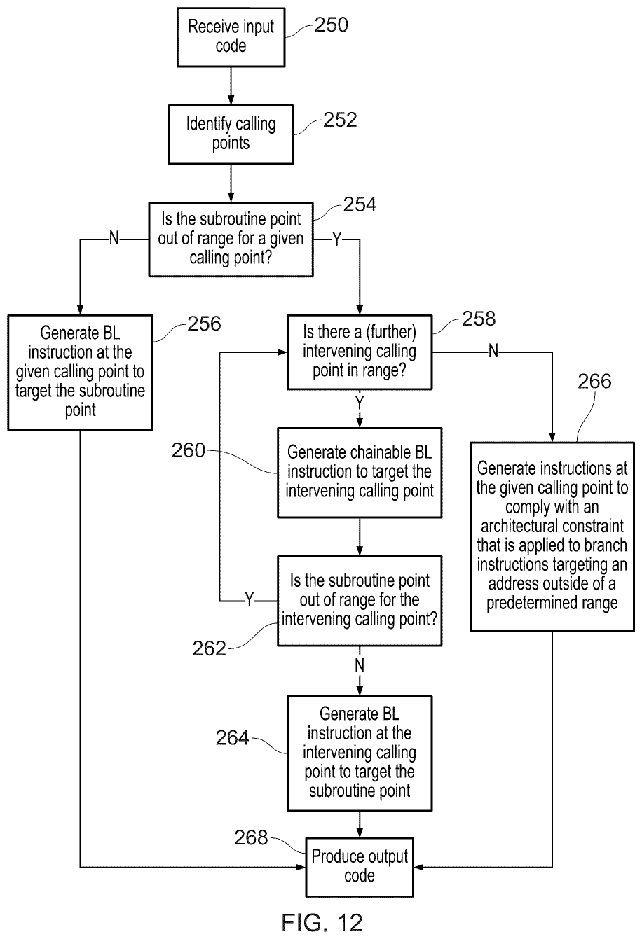

FIG. 12 illustrates a sequence of steps for the compiler 200 while processing the input code to generate output code. It will be appreciated that the compiler may also follow other processes for generating output code that are not described here for conciseness. It will also be appreciated that the compiler 200 may perform the process through one or more iterations, where each iteration of the process may include additional optimisations or restrictions added into the output code. Hence, the steps shown in FIG. 12 do not necessarily need to be performed by the compiler 200 in the illustrated order, and may be split into different iterations of code optimisations.

The process begins with step 250, in which the input code is received. The input code may only be a section of an overall computer program. As mentioned above, the compiler determines branch information from subroutine calls written into the input code to identify one or more points at which program flow is to be non-sequentially changed. From these, calling points may be identified at step 252. The calling points represent points at which the program flow is to be non-sequentially changed to a subroutine point which represents a point in the input code where the same series of instructions are called a plurality of times.

At step 254, it is determined whether the subroutine point is out of range for a given calling point. This may be determined based on an instruction address offset that would be expected in the output code between the given calling point and the subroutine point. As above, in an iterative process, this instruction address offset may be different in different iterations, so step 254 may rely on a provisional or assumed instruction address offset. Whether or not the subroutine point is out of range may therefore be determined based on the instruction address offset exceeding a predetermined threshold, which may be defined based on the particular architecture for which the compiler 200 is configured to generate code for. Accordingly, the predetermined threshold used by the compiler 200 may be sized to account for one or more of the architectural constraints described previously.

If the subroutine point is within range of the given calling point, then at step 256, the compiler 200 generates a BL instruction at the given calling point to target the subroutine point. It is not necessary for this BL instruction to be a chainable variant, but in some examples, e.g. when the instruction set architecture does not distinguish chainable and non-chainable variants, the BL instruction generated at step 256 may be a chainable variant.

If the subroutine point is out of range of the given calling point, then at step 258, it is determined whether an intervening calling point is within range of the given calling point. For the purposes of this example, the intervening calling point is required to also be a point at which the program flow non-sequentially changes to the subroutine point, i.e. the same subroutine point as the given calling point. If such an intervening calling point exists within range, then at step 260, the compiler 200 generates a chainable variant of a BL instruction which targets the intervening calling point. At step 262, it is then determined whether the subroutine is out of range for the intervening calling point. This step effectively acts to determine whether the chain of BL instructions is long enough to reach the subroutine point, or whether the chain should be extended. If the subroutine point is still out of range for the intervening calling point, then the process returns to step 258 to identify whether a further intervening calling point exists. Step 258 to step 262 may be repeated as many times as necessary such that a chain of BL instructions, each BL instruction targeting the address of the next BL instruction, arrives at an intervening calling point which is within range of the subroutine point. Accordingly, once it is determined that the subroutine point is within range of the latest intervening calling point, at step 264, a BL instruction is generated at the intervening calling point to target the subroutine point. This therefore ends the chain of BL instructions.

If no intervening calling point exists in range of the given calling point at step 258 (or if extending the chain, if no further intervening calling point exists in range of the preceding intervening calling point), then the compiler 200 may determine that a chain of BL instructions is not suitable for the given calling point. Accordingly, at step 266, the compiler 200 generates instructions at the given calling point to comply with the architectural constraints that is applied to branch instructions targeting an address outside of the predetermined range. For example, step 266 may involve inserting instructions for performing a guard check, or instructions for deriving the target address of the subroutine point and storing it in a register which may be referenced by a BLR instruction.

In some examples, the compiler 200 may be periodically determined whether extending the chain of BL instructions would be beneficial. Such a determination may be performed at regular occurrences of step 262, e.g. after adding 4 chainable BL instructions to the chain. It will be appreciated that in some examples, a chain may be generated to contain so many chainable BL instructions, that the additional overhead required by a performing a guard check or using a BLR instruction may be less than executing every ‘link’ in the chain. If so, then the compiler 200 may optimise the code by removing the chain of BL instructions and replacing them with the instructions to comply with the architectural constraint at step 266.

After any of steps 256, 264 or 266 described above, the compiler 200 produces the output code at step 268. It will be appreciated that the output code could be input again for one or more iterations of the compiler process to further optimise the code. Alternatively, the output code may be output for performance, e.g. by the apparatus 2. If the compiler 200 is implemented as a just-in-time compiler, then the output code may be input to the pipeline 4. Otherwise, the output code may be written into an executable file to be executed later.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

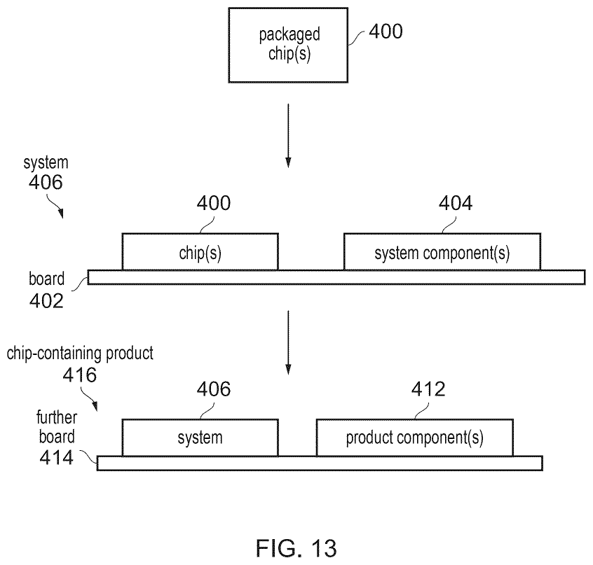

As shown in FIG. 13, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

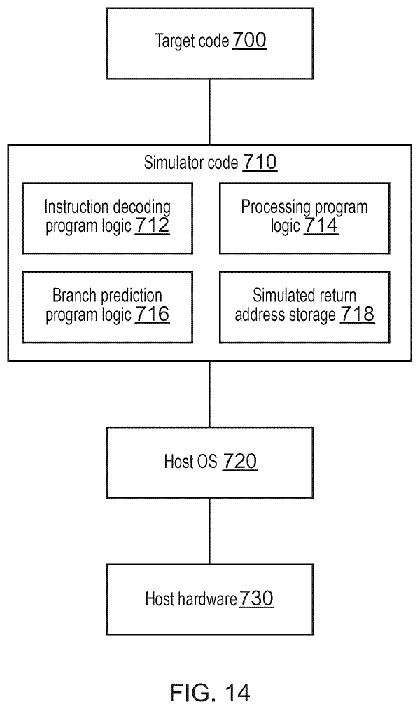

FIG. 14 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators. Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700, including may be executed from within the instruction execution environment using the simulator program 710, so that a host computer 730 which does not actually have the hardware features of the apparatus 2 discussed above can emulate these features. In particular, the host computer 730 can emulate the decode stage 10, execute stage 16, branch predictor 40 and link register 54 from apparatus 2 by using the instruction decoding program logic 712, the processing program logic 714, the branch prediction program logic 716 and the simulated return address storage 718 respectively contained within the simulator code 710.

Some examples are set out in the following clauses:
(1) An apparatus comprising:
   an instruction decoder configured to decode instructions; and
   processing circuitry configured to perform data processing in response to instructions decoded by the instruction decoder, wherein
   in response to a first branch-with-link instruction indicative of a hint that a future return instruction is expected to return processing to an instruction subsequent to the first branch-with-link instruction following processing of a function called by the first branch-with-link instruction, the instruction decoder is configured to control the processing circuitry to:
      trigger a non-sequential change of program flow to an instruction at a target address, and
      set, to a return address storage location, an address of the instruction subsequent to the first branch-with-link instruction; and
      at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.
(2) The apparatus of clause (1), wherein
   in response to the non-return-address-setting branch-with-link instruction, the instruction decoder is configured to control processing circuitry to:
      trigger a non-sequential change of program flow to an instruction at a target address of the non-return-address-setting branch-with-link instruction; and
      suppress updating the return address storage location.
(3) The apparatus of clause (1) or clause (2), wherein in response to a given branch-with-link instruction encountered without the given branch-with-link instruction being at a target address of a preceding instance of the chainable variant of the branch-with-link instruction, the instruction decoder is configured to treat the given branch-with-link instruction as a return-address-setting branch-with-link instruction for which update of the return address storage location is permitted.
(4) The apparatus of any preceding clause, wherein
   at least when the first branch-with-link instruction is the chainable variant, the instruction decoder is configured to control the processing circuitry to set a chaining indicator to indicate that a chaining condition is satisfied, wherein
   the processing circuitry is configured to determine, based on the chaining indicator, whether to treat a given branch-with-link instruction as the non-return-address-setting branch-with-link instruction.
(5) The apparatus of clause (4), wherein in response to the given branch-with-link instruction when the chaining indicator indicates that the chaining condition is not satisfied, the instruction decoder is configured to cause the given branch-with-link instruction to be treated as a return-address-setting branch-with-link instruction for which update of the return address storage location is permitted.
(6) The apparatus of clause (4) or clause (5), wherein in response to a non-chaining instruction when the chaining indicator indicates that the chaining condition is satisfied, the instruction decoder is configured to control the processing circuitry to set the chaining indicator to indicate that the chaining condition is not satisfied.
(7) The apparatus of clause (6), wherein the non-chaining instruction comprises one or more of:
   a non-branch instruction;
   a branch instruction that is not indicative of a hint that a future return instruction is expected to return processing to an instruction subsequent to the branch instruction; and
   a branch-with-link instruction that is not the chainable variant.
(8) The apparatus of any of clause (4) to (7), wherein the chaining indicator comprises one or more bits of a machine state register.
(9) The apparatus of any preceding clause, comprising:
   branch prediction circuitry configured to capture, in response to identifying an address predicted to correspond to a predicted branch-with-link instruction, a predicted return address associated with an instruction subsequent to the predicted branch-with-link instruction,
   wherein at least when the predicted branch-with-link instruction is predicted to:
      be the chainable variant, and
      target a further branch-with-link instruction,
      the branch prediction circuitry is configured to generate a prediction that the further branch-with-link instruction is to be taken, without capturing a further return address indicating an instruction subsequent to the further branch-with-link instruction.
(10) The apparatus of clause (9), wherein at least when the predicted branch-with-link instruction is predicted to be the chainable variant, the branch prediction circuitry is configured to set a chain prediction indicator to indicate that a chaining condition is satisfied, and
   in response to a branch-with-link instruction being predicted while the chain prediction indicator is set to indicate that the chaining condition is satisfied, the branch prediction circuitry is configured to suppress return address capture for that branch-with-link instruction.
(11) The apparatus of clause (10), wherein in response to predicting occurrence of a non-chaining instruction, the branch prediction circuitry is configured to set the chain prediction indicator to indicate that the chaining condition is not satisfied.
(12) The apparatus of any preceding clause, wherein the first branch-with-link instruction comprises an identifier of whether the first branch-with-link is the chainable variant.
(13) The apparatus of any of clauses (1) to (11), wherein the instruction decoder is configured to identify the first branch-with-link instruction as the chainable variant in dependence on a mode indication held in a control register.
(15) The apparatus of any preceding clause, wherein the processing circuitry is configured to process instructions according to an instruction set architecture which imposes an architectural constraint on the first branch-with-link instruction which causes branching from the first branch-with-link instruction to a target address outside a predetermined range from an instruction address of the first branch-with-link instruction to be more restricted in comparison to branching from the first branch-with-link instruction to a target address within the predetermined range from the instruction address of the first branch-with-link instruction.
(15) The apparatus of clause (14), wherein, according to the architectural constraint:
   in response to the first branch-with-link instruction when the target address is outside the predetermined range from the instruction address of the first branch-with-link instruction, the processing circuitry is configured to perform a guard check to verify whether an instruction at the target address corresponds to one of a set of permitted branch target instructions; and
   in response to the first branch-with-link instruction when the target address is within the predetermined range from the instruction address of the first branch-with-link instruction, the processing circuitry is configured to omit the guard check.
(16) The apparatus of clause (14), wherein the first branch-with-link instruction comprises a target address field for identifying the target address as a relative address offset relative to the instruction address of the first branch-with-link instruction, and the architectural constraint comprises an encoding constraint restricting a maximum address offset supported by the target address field, such that the first branch-with-link instruction is incapable of branching to a target address outside the predetermined range from the instruction address of the first branch-with-link instruction.
(17) A system comprising:
   the apparatus of any preceding claim, implemented in at least one packaged chip;
   at least one system component; and
   a board,
   wherein the at least one packaged chip and the at least one system component are assembled on the board.
(18) A chip-containing product comprising the system of clause (17), wherein the system is assembled on a further board with at least one other product component.
(19) A method comprising:
   decoding instructions; and
   performing data processing in response to decoded instructions, wherein
   in response to a first branch-with-link instruction indicative of a hint that a future return instruction is expected to return processing to an instruction subsequent to the first branch-with-link instruction following processing of a function called by the first branch-with-link instruction:
      triggering a non-sequential change of program flow to an instruction at a target address, and
      setting, to a return address storage location, an address of the instruction subsequent to the first branch-with-link instruction; and
      at least when the first branch-with-link instruction is a chainable variant and the instruction at the target address comprises a second branch-with-link instruction, causing the second branch-with-link instruction to be treated as a non-return-address-setting branch-with-link instruction for which update of the return address storage location is suppressed.
(20) Computer-readable code for fabrication of an apparatus comprising:
   an instruction decoder configured to decode instructions; and
   processing circuitry configured to perform data processing in response to instructions decoded by the instruction decoder, wherein
   in response to a first branch-with-link instruction indicative of a hint that a future return instruction is expected to return processing to an instruction subsequent to the first branch-with-link instruction following processing of a function called by the first branch-with-link instruction, the instruction decoder is configured to control the processing circuitry to:
      trigger a non-sequential change of program flow to an instruction at a target address, and
      set, to a return address storage location, an address of the instruction subsequent to the first branch-with-link instruction; and
      at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.
(21) A computer program for controlling a host data processing apparatus to provide an instruction execution environment comprising:
   instruction decoding program logic configured to decode instructions; and
   processing program logic configured to perform data processing in response to instructions decoded by the instruction decoding program logic, wherein
   in response to a first branch-with-link instruction indicative of a hint that a future return instruction is expected to return processing to an instruction subsequent to the first branch-with-link instruction following processing of a function called by the first branch-with-link instruction, the instruction decoding program logic is configured to control the processing program logic to:
      trigger a non-sequential change of program flow to an instruction at a target address, and
      set, to a return address storage location, an address of the instruction subsequent to the first branch-with-link instruction; and
      at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.
(22) A computer-readable medium storing the computer-readable code of clause (20) or the computer program of (21).
(23) A method of compiling a sequence of program instructions to generate a compiled program, the method comprising:
   determining branch information indicative of a given calling point of program flow at which the program flow is to be non-sequentially changed to a subroutine point, for which an instruction address offset between the given calling point and the subroutine point exceeds a predetermined threshold;
   identifying whether an intervening calling point exists between the given calling point and the subroutine point, the intervening calling point comprising a point at which the program flow is to be non-sequentially changed to the subroutine point, wherein an instruction address offset between the given calling point and the intervening calling point does not exceed the predetermined threshold; and
   in response to identifying that the intervening calling point exists, generating a chainable variant of a branch-with-link instruction for the given calling point, the chainable variant of the branch-with-link instruction specifying a target address corresponding to the intervening calling point, wherein the chainable variant of the branch-with-link instruction, when executed, causes:
      a non-sequential change of program flow to the intervening calling point;
      an address of an instruction subsequent to the chainable variant of the branch-with-link instruction to be set to a return address storage location; and
      a further branch-with-link instruction at the intervening calling point to be treated as a non-return-address-setting branch-with-link instruction, for which updating the return address storage location is suppressed.
(24) A computer-readable storage medium storing a computer program comprising instructions which, when executed by a data processing apparatus, control the data processing apparatus to perform the method of clause (23).

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
an instruction decoder configured to decode instructions; and
processing circuitry configured to perform data processing in response to instructions decoded by the instruction decoder, wherein
in response to a first branch-with-link instruction indicative of a hint that a future return instruction is expected to return processing to an instruction subsequent to the first branch-with-link instruction following processing of a function called by the first branch-with-link instruction, the instruction decoder is configured to control the processing circuitry to:
trigger a non-sequential change of program flow to an instruction at a target address, and
set, to a return address storage location, an address of the instruction subsequent to the first branch-with-link instruction; and
at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.

2. The apparatus of claim 1, wherein
in response to the non-return-address-setting branch-with-link instruction, the instruction decoder is configured to control processing circuitry to:
trigger a non-sequential change of program flow to an instruction at a target address of the non-return-address-setting branch-with-link instruction; and
suppress updating the return address storage location.

3. The apparatus of claim 1, wherein in response to a given branch-with-link instruction encountered without the given branch-with-link instruction being at a target address of a preceding instance of the chainable variant of the branch-with-link instruction, the instruction decoder is configured to treat the given branch-with-link instruction as a return-address-setting branch-with-link instruction for which update of the return address storage location is permitted.

4. The apparatus of claim 1, wherein
at least when the first branch-with-link instruction is the chainable variant, the instruction decoder is configured to control the processing circuitry to set a chaining indicator to indicate that a chaining condition is satisfied, wherein
the processing circuitry is configured to determine, based on the chaining indicator, whether to treat a given branch-with-link instruction as the non-return-address-setting branch-with-link instruction.

5. The apparatus of claim 4, wherein in response to the given branch-with-link instruction when the chaining indicator indicates that the chaining condition is not satisfied, the instruction decoder is configured to cause the given branch-with-link instruction to be treated as a return-address-setting branch-with-link instruction for which update of the return address storage location is permitted.

6. The apparatus of claim 4, wherein in response to a non-chaining instruction when the chaining indicator indicates that the chaining condition is satisfied, the instruction decoder is configured to control the processing circuitry to set the chaining indicator to indicate that the chaining condition is not satisfied.

7. The apparatus of claim 6, wherein the non-chaining instruction comprises one or more of:
a non-branch instruction;
a branch instruction that is not indicative of a hint that a future return instruction is expected to return processing to an instruction subsequent to the branch instruction; and
a branch-with-link instruction that is not the chainable variant.

8. The apparatus of any of claims 4, wherein the chaining indicator comprises one or more bits of a machine state register.

9. The apparatus of claim 1, comprising:
branch prediction circuitry configured to capture, in response to identifying an address predicted to correspond to a predicted branch-with-link instruction, a predicted return address associated with an instruction subsequent to the predicted branch-with-link instruction,
wherein at least when the predicted branch-with-link instruction is predicted to:
be the chainable variant, and
target a further branch-with-link instruction,
the branch prediction circuitry is configured to generate a prediction that the further branch-with-link instruction is to be taken, without capturing a further return address indicating an instruction subsequent to the further branch-with-link instruction.

10. The apparatus of claim 9, wherein at least when the predicted branch-with-link instruction is predicted to be the chainable variant, the branch prediction circuitry is configured to set a chain prediction indicator to indicate that a chaining condition is satisfied, and
in response to a branch-with-link instruction being predicted while the chain prediction indicator is set to indicate that the chaining condition is satisfied, the branch prediction circuitry is configured to suppress return address capture for that branch-with-link instruction.

11. The apparatus of claim 10, wherein in response to predicting occurrence of a non-chaining instruction, the branch prediction circuitry is configured to set the chain prediction indicator to indicate that the chaining condition is not satisfied.

12. The apparatus of claim 1, wherein the processing circuitry is configured to process instructions according to an instruction set architecture which imposes an architectural constraint on the first branch-with-link instruction which causes branching from the first branch-with-link instruction to a target address outside a predetermined range from an instruction address of the first branch-with-link instruction to be more restricted in comparison to branching from the first branch-with-link instruction to a target address within the predetermined range from the instruction address of the first branch-with-link instruction.

13. The apparatus of claim 12, wherein, according to the architectural constraint:
in response to the first branch-with-link instruction when the target address is outside the predetermined range from the instruction address of the first branch-with-link instruction, the processing circuitry is configured to perform a guard check to verify whether an instruction at the target address corresponds to one of a set of permitted branch target instructions; and
in response to the first branch-with-link instruction when the target address is within the predetermined range from the instruction address of the first branch-with-link instruction, the processing circuitry is configured to omit the guard check.

14. The apparatus of claim 12, wherein the first branch-with-link instruction comprises a target address field for identifying the target address as a relative address offset relative to the instruction address of the first branch-with-link instruction, and the architectural constraint comprises an encoding constraint restricting a maximum address offset supported by the target address field, such that the first branch-with-link instruction is incapable of branching to a target address outside the predetermined range from the instruction address of the first branch-with-link instruction.

15. A system comprising:
the apparatus of claim 1, implemented in at least one packaged chip;
at least one system component; and
a board,
wherein the at least one packaged chip and the at least one system component are assembled on the board.

16. A chip-containing product comprising the system of claim 17, wherein the system is assembled on a further board with at least one other product component.

17. A non-transitory computer-readable medium storing computer-readable code for fabrication of an apparatus according to claim 1.

18. A non-transitory computer-readable medium storing computer program for controlling a host data processing apparatus to provide an instruction execution environment comprising:
instruction decoding program logic configured to decode instructions; and
processing program logic configured to perform data processing in response to instructions decoded by the instruction decoding program logic, wherein
in response to a first branch-with-link instruction indicative of a hint that a future return instruction is expected to return processing to an instruction subsequent to the first branch-with-link instruction following processing of a function called by the first branch-with-link instruction, the instruction decoding program logic is configured to control the processing program logic to:
trigger a non-sequential change of program flow to an instruction at a target address, and
set, to a return address storage location, an address of the instruction subsequent to the first branch-with-link instruction; and
at least when the first branch-with-link instruction is a chainable variant and the instruction at the target address comprises a second branch-with-link instruction, cause the second branch-with-link instruction to be treated as a non-return-address-setting branch-with-link instruction for which update of the return address storage location is suppressed.

19. A method of compiling a sequence of program instructions to generate a compiled program, the method comprising:
determining branch information indicative of a given calling point of program flow at which the program flow is to be non-sequentially changed to a subroutine point, for which an instruction address offset between the given calling point and the subroutine point exceeds a predetermined threshold;
identifying whether an intervening calling point exists between the given calling point and the subroutine point, the intervening calling point comprising a point at which the program flow is to be non-sequentially changed to the subroutine point, wherein an instruction address offset between the given calling point and the intervening calling point does not exceed the predetermined threshold; and
in response to identifying that the intervening calling point exists, generating a chainable variant of a branch-with-link instruction for the given calling point, the chainable variant of the branch-with-link instruction specifying a target address corresponding to the intervening calling point, wherein the chainable variant of the branch-with-link instruction, when executed, causes:
a non-sequential change of program flow to the intervening calling point;
an address of an instruction subsequent to the chainable variant of the branch-with-link instruction to be set to a return address storage location; and
a further branch-with-link instruction at the intervening calling point to be treated as a non-return-address-setting branch-with-link instruction, for which updating the return address storage location is suppressed.

20. A non-transitory computer-readable storage medium storing a computer program comprising instructions which, when executed by a data processing apparatus, control the data processing apparatus to perform the method of claim 19.
